(19) United States
(12) Patent Application Publication
(10) Pub. No.: US 2012/0180487 A1
(43) Pub. Date: Jul. 19, 2012

(54) SYSTEM FOR FLOW CONTROL IN MULTI-TUBE FUEL NOZZLE

(75) Inventors: Jong Ho Uhm, Simpsonville, SC (US); Thomas Edward Johnson, Greer, SC (US)

(73) Assignee: General Electric Company, Schenectady, NY (US)

(21) Appl. No.: 13/009,299

(22) Filed: Jan. 19, 2011

(51) Int. Cl. F02C 7/22; B05B 1/14

(52) U.S. Cl. 60/737; 239/558

(57) ABSTRACT

A system includes a multi-tube fuel nozzle. The multi-tube fuel nozzle includes a fuel conduit, a fuel chamber coupled to the fuel conduit, and multiple tubes concentrically arranged in multiple rows about a central axis of the multi-tube fuel nozzle and extending through the fuel chamber to a downstream end portion of the multi-tube fuel nozzle. The multiple tubes include fluids flow and different flow control features including at least one of different fuel/air premixing ratios, different tube diameters, or different outlet distances relative to the downstream end portion.

### STATEMENT REGARDING FEDERALLY SPONSORED RESEARCH & DEVELOPMENT

This invention was made with Government support under contract number DE-FC26-05NT42643 awarded by the Department of Energy. The Government has certain rights in the invention.

### BACKGROUND OF THE INVENTION

The subject matter disclosed herein relates to a turbine engine and, more specifically, to a fuel nozzle with an improved design to enhance the operability and durability of the fuel nozzle.

A gas turbine engine combusts a mixture of fuel and air to generate hot combustion gases, which in turn drive one or more turbine stages. In particular, the hot combustion gases force turbine blades to rotate, thereby driving a shaft to rotate one or more loads, e.g., an electrical generator. The gas turbine engine includes a fuel nozzle to inject fuel and air into a combustor. Unfortunately, a portion of the fuel nozzle may experience a large recirculation zone of hot combustion products, which can result in flame holding, flash back, hot spots, and potential damage of the fuel nozzle.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a multi-tube fuel nozzle. The multi-tube fuel nozzle includes a fuel conduit, a fuel chamber coupled to the fuel conduit, and multiple tubes concentrically arranged in multiple rows about a central axis of the multi-tube fuel nozzle and extending through the fuel chamber to a downstream end portion of the multi-tube fuel nozzle. The multiple tubes include fluids flow and different flow control features including at least one of different fuel/air premixing ratios, different tube diameters, or different outlet distances relative to the downstream end portion.

In accordance with a second embodiment, a system includes a multi-tube fuel nozzle. The multi-tube fuel nozzle includes a fuel conduit, a fuel chamber coupled to the fuel conduit, and a first tube extending through the fuel chamber. The first tube includes a first axis disposed at a first radial offset from a central axis of the multi-tube fuel nozzle. The multi-tube fuel nozzle also includes a second tube extending through the fuel chamber. The second fuel tube includes a second axis parallel to the first axis, the second axis is disposed at a second radial offset from the central axis of the multi-tube fuel nozzle, the second radial offset is greater than the first radial offset, and the first and second tubes include fluids flow and are structurally different from one another to define different control features.

In accordance with a third embodiment, a system includes a multi-tube fuel nozzle. The multi-tube fuel nozzle includes a fuel conduit, a fuel chamber coupled to the fuel conduit, and a first tube extending through the fuel chamber. The first tube includes a first axis disposed at a first radial offset from a central axis of the multi-tube fuel nozzle. The multi-tube fuel nozzle includes a second tube extending through the fuel chamber. The second tube includes a second axis disposed at a second radial offset from the central axis of the multi-tube fuel nozzle and the second radial offset is greater than the first radial offset. The multi-tube fuel nozzle includes a third tube extending through the fuel chamber. The third tube includes a third axis disposed at a third radial offset from the central axis of the multi-tube nozzle and the third radial offset is greater than the second radial offset. The first, second, and third tubes include fluids flow and at least two different flow control features including different fuel/air premixing ratios, different tube diameters, or different outlet distances relative to a downstream end portion of the multi-tube fuel nozzle.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a turbine system having a fuel nozzle with an improved design to enhance operability and durability;

FIG. 2 is a cross-sectional side view of an embodiment of a combustor of FIG. 1 with multiple fuel nozzles;

FIG. 3 is a front plan view of an embodiment of the combustor including the multiple fuel nozzles;

FIG. 4 is a cross-sectional side view of an embodiment of a center fuel nozzle of FIG. 3, taken along line 4-4;

FIG. 5 is a cross-sectional side view of an embodiment of the center fuel nozzle of FIG. 3, taken along line 4-4;

FIG. 6 is a cross-sectional side view of an embodiment of the center fuel nozzle of FIG. 3, taken along line 4-4;

FIG. 7 is a partial cross-sectional side view of an embodiment of the center fuel nozzle of FIG. 4, taken within line 7-7;

FIG. 8 is a partial cross-sectional side view of an embodiment of the center fuel nozzle of FIG. 4, taken within line 7-7; and

FIG. 9 is a partial cross-sectional side view of an embodiment of the center fuel nozzle FIG. 4, taken within line 7-7.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems for improving the operability and durability of multi-tube fuel nozzles. Certain combustors include multiple multi-tube fuel nozzles distributed circumferentially about a center multi-tube fuel nozzle. Fuel enters tubes of the multi-tube fuel nozzles and premixes with air prior to injection from the fuel nozzles. Upon injection from the fuel nozzles, the air-fuel mixture combusts to generate hot combustion products. Unfortunately, without the disclosed embodiments, hot combustion products may recirculate near the center multi-tube fuel nozzle to form a large recirculation zone, which generates hot spots near a central portion of the center multi-tube fuel nozzle. For example, the tubes of the center multi-tube fuel nozzle may extend beyond a downstream end portion of the fuel nozzle to improve flame holding/flashback margin and to reduce NOx. Tube ends protruding from the center multi-tube fuel nozzle may allow a flame to stabilize on the ends, causing damage to the tubes within the hot spots near the central portion of the fuel nozzle.

Embodiments of the present disclosure provide a system that includes a multi-tube fuel nozzle with different flow control features to improve the operability and durability of the fuel nozzle. For example, the different flow control features are configured to control flow distribution (e.g., to provide a uniform flow or controlled flow profile) to reduce low velocity zones and/or recirculation zones of hot combustion products along the downstream end of the multi-tube fuel nozzle. As a result, the flow control features reduce the possibility of flame holding, flash back, hot spots, and general damage associated with the recirculation zones. In certain embodiments, the multi-tube fuel nozzle includes multiple tubes extending through a fuel chamber to a downstream end portion, where the tubes include different flow control features. The different flow control features may include different fuel/air premixing ratios, different tube diameters, or different outlet distances relative to the downstream end portion. For example, the flow control features may change in a radial direction away from a central axis of the multi-tube fuel nozzle. The flow control features also include different numbers, sizes, and shapes of the fuel inlets in the tubes. In further embodiments, the multi-tube fuel nozzle includes a first tube and second tube extending through a fuel chamber, where each tube includes an axis offset from a central axis of the fuel nozzle. The radial offset of the second tube is greater than the first tube and the first and second tubes are structurally different from one another to define different flow control features. In yet further embodiments, the multi-fuel nozzle includes a first tube, second tube, and third tube extending through the fuel chamber, where each tube includes an axis offset from the central axis of the fuel nozzle. The radial offset of the third tube is greater than the offsets of the first and second tubes, and the radial offset of the second tube is greater than the radial offset of the first tube. The first, second, and third tubes include at least two different flow control features including different fuel/air premixing ratios, different tube diameters, or different outlet distances relative to the downstream end portion of the multi-tube fuel nozzle. The different flow control features of these embodiments may reduce the hot spots near the central portion of the multi-tube nozzle and increase the operability and durability of the fuel nozzle.

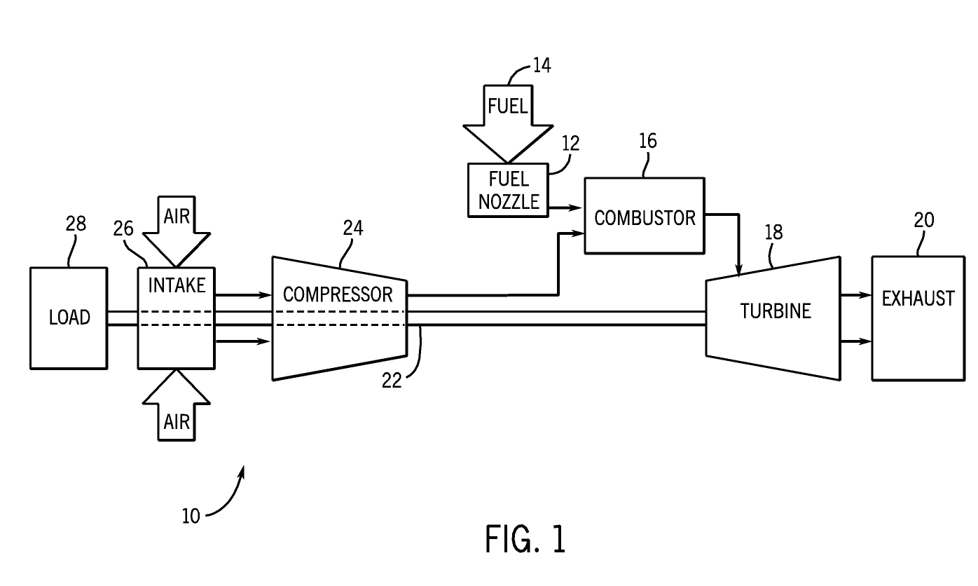

Turning now to the drawings and referring first to FIG. 1, a block diagram of an embodiment of a turbine system 10 is illustrated. As described in detail below, the disclosed turbine system 10 (e.g., a gas turbine engine) may employ one or more fuel nozzles 12 (e.g., multi-tube fuel nozzles) with an improved design to increase operability and durability of the fuel nozzles 12 in the turbine system 10. For example, certain fuel nozzles 12 (e.g., a multi-tube fuel nozzle) include different flow control features configured to control flow distribution (e.g., to provide a uniform flow or controlled flow profile) to reduce low velocity zones and/or recirculation zones of hot combustion products along a downstream end portion of the nozzle 12. As a result, the flow control features reduce the possibility of flame holding, flash back, hot spots, and general damage associated with the recirculation zones. In certain embodiments, the system 10 includes a plurality of fuel nozzles 12 arranged along a common plane or axially staggered relative to one another. For example, a plurality of fuel nozzles 12 (e.g., 2-10) may be arranged around a central fuel nozzle 12. One or more of these fuel nozzles 12 may include the flow control features discussed in detail below.

The turbine system 10 may use liquid or gas fuel, such as natural gas and/or a hydrogen rich synthetic gas, to drive the turbine system 10. As depicted, one or more fuel nozzles 12 intake a fuel supply 14, mix the fuel with air, and distribute the air-fuel mixture into a combustor 16 in a suitable ratio for optimal combustion, emissions, fuel consumption, and power output. The turbine system 10 may include one or more fuel nozzles 12 located inside one or more combustors 16. The air-fuel mixture combusts in a chamber within the combustor 16, thereby creating hot pressurized exhaust gases. The combustor 16 directs the exhaust gases through a turbine 18 toward an exhaust outlet 20. As the exhaust gases pass through the turbine 18, the gases force turbine blades to rotate a shaft 22 along an axis of the turbine system 10. As illustrated, the shaft 22 may be connected to various components of the turbine system 10, including a compressor 24. The compressor 24 also includes blades coupled to the shaft 22. As the shaft 22 rotates, the blades within the compressor 24 also rotate, thereby compressing air from an air intake 26 through the compressor 24 and into the fuel nozzles 12 and/or combustor 16. The shaft 22 may also be connected to a load 28, which may be a vehicle or a stationary load, such as an electrical generator in a power plant or a propeller on an aircraft, for example. The load 28 may include any suitable device capable of being powered by the rotational output of the turbine system 10.

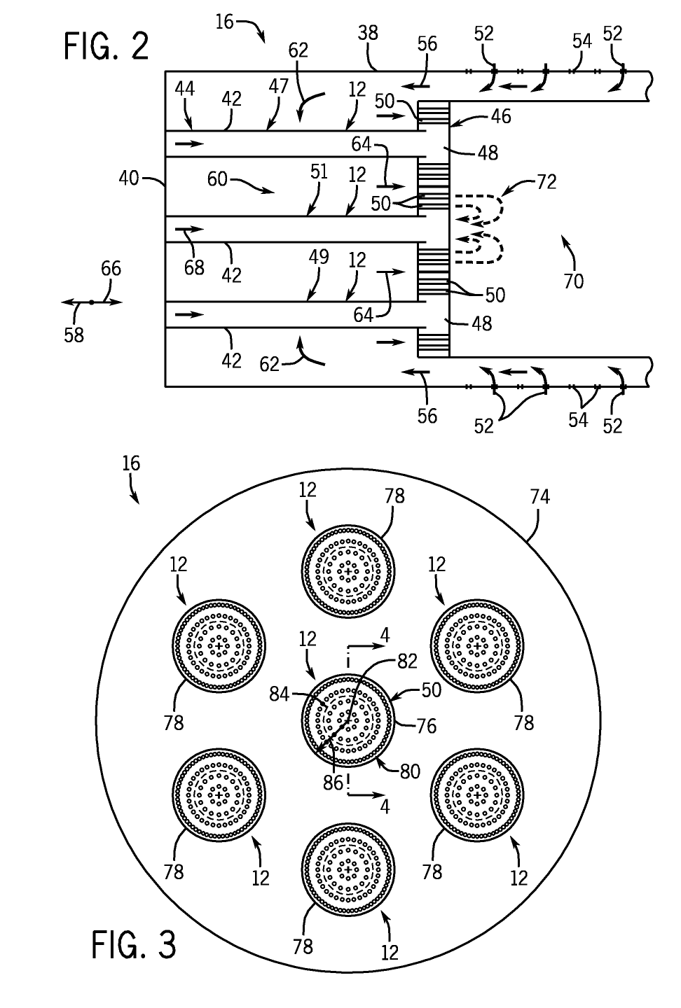

FIG. 2 is a cross-sectional side view of an embodiment of the combustor 16 of FIG. 1 with multiple fuel nozzles 12. The combustor 16 includes an outer casing or flow sleeve 38 and an end cover 40. Multiple fuel nozzles 12 (e.g., multi-tube fuel nozzles) are mounted within the combustor 16. Each fuel nozzle 12 includes a fuel conduit 42 extending from an upstream end portion 44 to a downstream end portion 46 of the nozzle 12. In addition, each fuel nozzle 12 includes a fuel chamber 48 coupled to the fuel conduit 42 and a plurality of tubes 50 both near the downstream end portion 46 as described in greater detail below. As discussed in detail below, the tubes of each fuel nozzle 12 (e.g., outer fuel nozzles 47 and 49 and central fuel nozzle 51) may have a variety of flow control features, such as different distances from the downstream end portion 46, different diameters, and/or different arrangements of fuel inlets (e.g., different number, size, and arrangement of fuel inlets). In certain embodiments, the plurality of tubes 50 is flush with the downstream end portion 46 of the fuel nozzle 12 (e.g., fuel nozzles 47, 49, and/or 51), while the tubes 50 of one or more fuel nozzles 12 have different diameters and/or different arrangements of fuel inlets. In other embodiments, the plurality of tubes 50 extend or protrude beyond the downstream end portion 46 of the fuel nozzle 12 (e.g., fuel nozzles 47, 49, and/or 50) with or without other flow control features. In one embodiment, the outer fuel nozzles 47 and 49 have a flush arrangement of the tubes 50, while the center fuel nozzle 51 has a staggered arrangement of the tubes 50. In some embodiments, both the center and outer fuel nozzles 47, 49, and 51 may include the flow control features.

Air (e.g., compressed air) enters the flow sleeve 38, as generally indicated by arrows 52, via one or more air inlets 54 and follows an upstream airflow path 56 in an axial direction 58 towards the end cover 40. Air then flows into an interior flow path 60, as generally indicated by arrows 62, and proceeds along a downstream airflow path 64 in the axial direction 66 through the plurality of tubes 50 of each fuel nozzle 12. Fuel flows in the axial direction 66 along a fuel flow path 68 through each fuel conduit 42 towards the downstream end portion 46 of each fuel nozzle 12. Fuel then enters the fuel chamber 48 of each fuel nozzle 12 and mixes with air within the plurality of tubes 50. The fuel nozzles 12 inject the air-fuel mixture into a combustion region 70 in a suitable ratio for optimal combustion, emissions, fuel consumption, and power output. At the downstream end portion 46 of the center fuel nozzle 51, combustion products may recirculate to form a large recirculation region 72 and to generate hot spots on portions of the center fuel nozzle 51 without the flow control features of the disclosed embodiments. However, the disclosed embodiments employ flow control features to control flow distribution (e.g., to provide a uniform flow or controlled flow profile) at the downstream end portions 46 of the fuel nozzles 12, thereby reducing the low velocity regions or recirculation zones of hot combustion products. As a result, the flow control features may reduce the possibility of flame holding, flash back, hot spots, and other damage of the fuel nozzles 12.

FIG. 3 is a front plan view of an embodiment of the combustor 16 including multiple fuel nozzles 12 (e.g., multi-tube fuel nozzles). The combustor 16 includes a cap member 74 with multiple fuel nozzles 12 disposed therethrough. As illustrated, the combustor 16 includes a fuel nozzle 12 (i.e., center fuel nozzle 76) centrally located within the cap member 74 of the combustor 16. The combustor 16 also includes multiple fuel nozzles 12 (i.e., outer fuel nozzles 78) disposed circumferentially about the center fuel nozzle 76. As illustrated, six outer fuel nozzles 78 surround the center fuel nozzle 76. However, in certain embodiments, the number of fuel nozzles 12 as well as the arrangement of the fuel nozzles 12 may vary. For example, the fuel nozzles 12 may be arranged as described in U.S. patent application Ser. No. 12/394,544 filed on Feb. 27, 2009, which is hereby incorporated by reference. Each fuel nozzle 12 includes the plurality of tubes 50. As illustrated, the plurality of tubes 50 of each fuel nozzle 12 is arranged in multiple rows 80. The rows 80 have a concentric arrangement about a central axis 82 of each fuel nozzle 12. In certain embodiments, the number of rows 80, number of tubes 50 per row 80, and arrangement of the plurality of tubes 50 may vary.

In certain embodiments, the plurality of tubes 50 of each outer fuel nozzle 78 may be flush with the downstream end portion 46, while at least some of the plurality of tubes 50 of the center fuel nozzle 76 may extend or protrude beyond the downstream end portion 46. As mentioned above, the disclosed flow control features (e.g., including variable protrusion of tubes 50) are configured to reduce the large recirculation region 72 and the stabilization of the flame on the protruding tube ends of the center fuel nozzle 76, thereby reducing hot spots as generally indicated by a region within dashed circle 84. The heat from these hot spots may cause damage to tubes 50 within this hot spot region 84 centrally located within fuel nozzle 76. As described in detail below, the plurality of tubes 50 may include different flow control features (e.g., protrusion distance, diameter, and fuel inlets) that change in a radial direction 86 away or outward from the central axis 82 of the fuel nozzle 12. These flow control features may even out the flow to eliminate the recirculation region 72 across the downstream end portion 46 of the center fuel nozzle 76, thus better distributing the heat across the downstream end portion 46 and reducing hot spots to increase operability and durability of the center fuel nozzle 76. For example, the flow control features may include different fuel/air premixing ratios, different tube diameters, or different outlet distances relative to the downstream end portion 46. In certain embodiments, the tubes 50 may include at least one, two, or three of the different flow control features above. In certain embodiments, only the center fuel nozzle 76 may include the flow control features. Alternatively, only the outer fuel nozzles 78 may include the flow control features. In some embodiments, both the center and outer fuel nozzles 76 and 78 may include the flow control features.

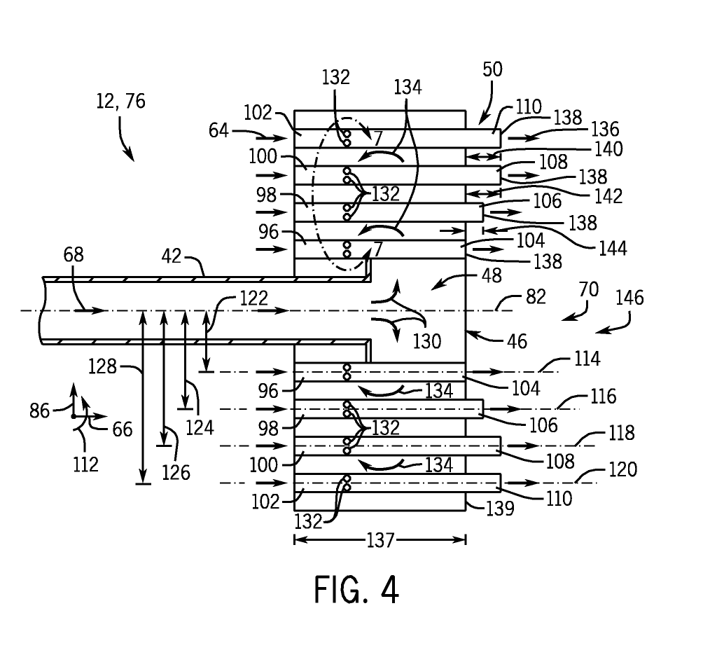

FIGS. 4-9 are cross-sectional side views of various embodiments of the fuel nozzle 12 (e.g., central fuel nozzle 76) of FIG. 3, taken along line 4-4, illustrating different flow control features to reduce low velocity regions or recirculation zones of hot combustion products. The flow control features discussed below are not limited to their respective embodiments and may be used in combination to improve the operability and durability of the fuel nozzle 12. FIG. 4 is a cross-sectional side view of an embodiment of the center fuel nozzle 76 of FIG. 3, taken along line 4-4, illustrating a staggered arrangement of tubes 50. As previously described, the fuel nozzle 76 (e.g., multi-tube fuel nozzle) includes the fuel conduit 42, the fuel chamber 48 coupled to the fuel conduit 42, and the plurality of tubes 50 extending through the fuel chamber 48 to the downstream end portion 46. Tubes 96, 98, 100, and 102 may each represent concentric rows 80 (i.e., 104, 106, 108, and 110) of tubes 50 disposed about the central axis 82 of the fuel nozzle 76 in a circumferential direction 112. For example, each row 104, 106, 108, and 110 of tubes 50 may represent a plurality of tubes 50 (e.g., 2 to 50 tubes 50) in an annular arrangement or circular pattern. Descriptions of the tubes 50 below may also apply to their respective rows 80. In other words, any discussion of the tubes 50 (e.g., tubes 96, 98, 100, and 102) is intended to include the respective rows 104, 106, 108, and 110 (e.g., multiple tubes per row). Each tube 50 includes an axis (i.e., 114, 116, 118, and 120) disposed at a radial offset (i.e., 122, 124, 126, and 128) from the central axis 82 of the fuel nozzle 76. For example, tubes 96, 98, 100, and 102 include axes 114, 116, 118, and 120, respectively. These axes 114, 116, 118, and 120 are parallel with respect to each other in the illustrated embodiment. However, the axes 114, 116, 118, and 120 may be non-parallel (e.g., converging or diverging) in other embodiments. The radial offsets 122, 124, 126, 128 increase in the radial direction 86 away from the central axis 82 of the fuel nozzle 76. As a result, the radial offset 128 of tube 102 is greater than the radial offsets 122, 124, and 126 of respective tubes 96, 98, and 100. Similarly, the radial offset 126 of tube 100 is greater than the radial offsets 122 and 124 of respective tubes 96 and 98, and the radial offset 124 of tube 98 is greater than the radial offset 122 of tube 96. In the illustrated embodiment, the radial spacing between tubes 50 is generally constant. However, other embodiments may have non-uniform radial spacing (e.g., increasing or decreasing) of the tubes 50 in the radial direction 86. As illustrated, the fuel nozzle 76 includes four rows 104, 106, 108, and 110. As described below, these tubes 96, 98, 100, and 102 (as well as their respective rows 104, 106, 108, and 110) may be structurally different to define different flow control features. Further, in certain embodiments, the number of rows 80, number of tubes 50 per row 80, and the arrangement of the plurality of tubes 50 may vary. For example, the number of rows may range from 2 to 10 or more and the number of tubes per row may range from 4 to 100.

As previously mentioned, air flows along a downstream airflow path 64 in the axial direction 66 through the plurality of tubes 50 of the fuel nozzle 76. Fuel flows in the axial direction 66 along the fuel flow path 68 through each fuel conduit 42 towards the downstream end portion 46 of each fuel nozzle 12. Fuel then enters the fuel chamber 48 and is diverted towards the plurality of tubes 50, as generally indicated by arrows 130. In certain embodiments, the fuel nozzle 12 may include a baffle to direct fuel flow within the fuel chamber 48. Fuel flows toward fuel inlets 132, as generally indicated by arrows 134, and mixes with air within the plurality of tubes 50. The fuel nozzle 76 injects the air-fuel mixture from the tubes 50, as generally indicated by arrows 136, into a combustion region 70 in a suitable ratio for optimal combustion, emissions, fuel consumption, and power output.

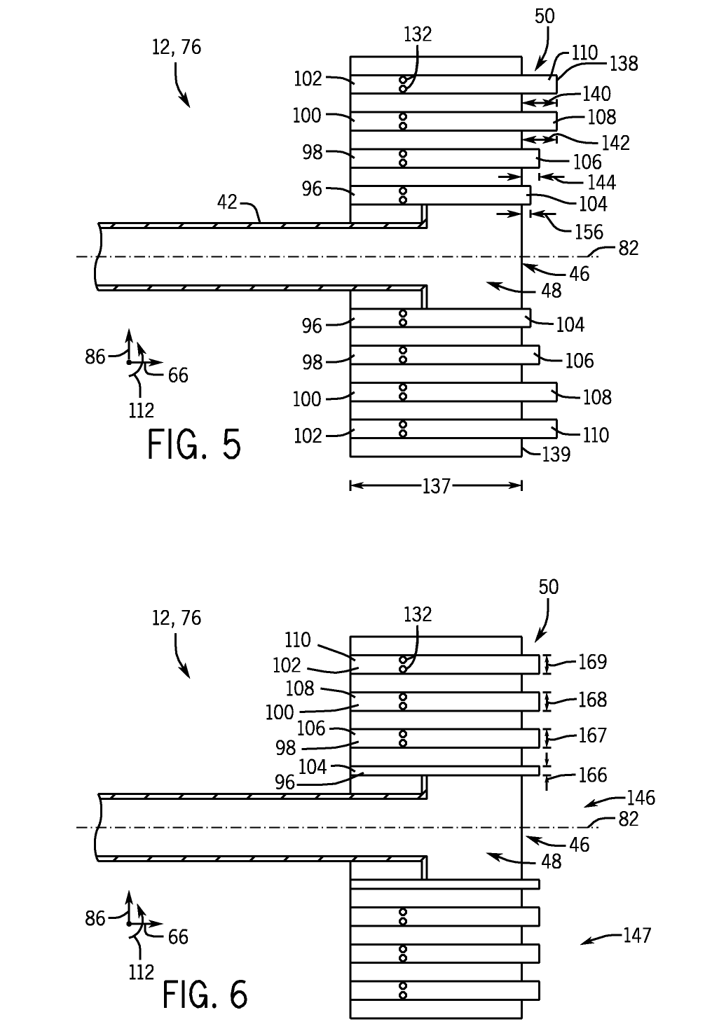

As previously mentioned, the fuel nozzle 76 includes flow control features that change in the radial direction 86 away or outward from the central axis 82 of the fuel nozzle 76. For example, the flow control features may include outlet distances of the tubes 50, diameters of the tubes 50, and fuel inlet 132 arrangements on the tubes 50. As illustrated, the flow control features include different outlet distances 140, 142, 144, and 156 (see FIG. 5) between the downstream end portion 46 of the fuel nozzle 76 and end portions 138 of the plurality of tubes 50. Indeed, the outlet distances 140, 142, 144, and 156 of the plurality of tubes 50 change in the radial direction 86 away from the central axis 82 of the fuel nozzle 76. For example, the outlet distances 140, 142, 144, and 156 may vary relative to an axial length 137 of a head portion 139 of the fuel nozzle 12 (e.g., 76). The outlet distances 140, 142, 144, and 156 may range from approximately 0 to 50, 0 to 25, or 0 to 15 percent of the axial length 137. For example, the outlet distances 140, 142, 144, and 156 may be approximately 0.1, 5, 10, 15, 25, 30, 35, 40, 45, or 50 percent, or any percent therebetween. The outlet distances 140, 142, 144, and 156 may range from approximately 0.01 D to 1.2 D (where D is inner diameter of the tubes 50). For example, the outlet distances 140, 142, 144, and 156 may be 0.01 D, 0.2 D, 0.4 D, 0.6 D, 0.8 D, 1.0 D, or 1.2 D, or any distance therebetween. As illustrated, tube 96 is flush-mounted with respect to the downstream end portion 46 of the fuel nozzle 76 and, thus, has an outlet distance 156 of 0. Tube 98 protrudes from the downstream end portion 46 of the fuel nozzle 76 and has the outlet distance 144 between the end portion 138 and the downstream end portion 46. End portions 138 of tubes 100 and 102 protrude at about the same outlet distances 142 and 140 from the downstream end portion 46 of the fuel nozzle 76. In certain embodiments, the outlet distances 140, 142, 144, and 156 incrementally change in an equal or variable amount from one tube 50 to another. For example, the outlet distances 140, 142, 144, and 156 may incrementally change by 1 to 50, 1 to 25, or 5 to 15 percent from one tube 50 to another in the radial direction 86. As illustrated, the outlet distance 144 increases from tube 96 to tube 98. The outlet distances 142 and 140 of tubes 100 and 102 increase from the outlet distance 144 of tube 98. In certain embodiments, at least both tubes 96 and 98 may be flush-mounted. However, the illustrated embodiment flush mount tubes 96. The flush-mounting of tube 96 eliminates contact with combustion products, while the lesser protrusion (i.e., lesser outlet distance 144) of tube 98 relative to tubes 100 and 102 reduces contact with combustion products. This provides less tube portions within the hot spots to stabilize the flame. In addition, this allows controlled flow distribution to reduce the recirculation region of hot combustion products 72, thereby reducing the possibility of hot spots about a central region 146 of the downstream end portion 46 of the fuel nozzle 76.

FIG. 5 is a cross-sectional side view of another embodiment of the center fuel nozzle 76 (e.g., multi-tube fuel nozzle) of FIG. 3, taken along line 4-4. FIG. 5 is as described above in FIG. 4 except tube 96 is not flush-mounted with respect to the downstream end portion 46 of the fuel nozzle 76. Instead, the end portion of tube 96 protrudes beyond the downstream end portion 46 to define the outlet distance 156. The different outlet distances 140, 142, and 144 of respective tubes 102, 100, and 98 are greater than the outlet distance 156 of tube 96. Indeed, outlet distance 144 increases from tube 96 to tube 98 with a further increase in outlet distances 142 and 140 from tube 98 to tubes 100 and 102. Similar to above, the lesser protrusion (i.e., lesser outlet distances 156 and 144) of tubes 96 and 98 relative to tubes 100 and 102 reduces contact with combustion products and enhances the operability and durability of the fuel nozzle 76.

Besides different outlet distances, the fuel nozzle 76 may include other flow control features (e.g., different tube diameters) to improve the operability and durability of the fuel nozzle 76. FIG. 6 is a cross-sectional side view of a further embodiment of the center fuel nozzle 76 (e.g., multi-tube fuel nozzle) of FIG. 3, taken along line 4-4. Generally, the fuel nozzle 76 is as described above in FIGS. 5 and 6, except for a few differences, such as the plurality of tubes 50 having the same outlet distances beyond the downstream end portion 46. In addition, the plurality of tubes 50 includes different tube diameters. Indeed, the different tube diameters of the plurality of tubes 50 change in the radial direction 86 away from the central axis 82 of the fuel nozzle 76. More specifically, the tube 96 has a diameter 166, tube 98 has a diameter 167, tube 100 has a diameter 168, and tube 102 has a diameter 169. In certain embodiments, the diameters 166, 167, 168, and 169 may progressively change (e.g., increase or decrease) in the radial direction 86 from one tube 50 to another. For example, the diameter 166, 167, 168, and 169 may incrementally increase by approximately 0 to 200, 0 to 100, or 0 to 50, or 0 to 25 percent from one tube 50 to another. By further example, the tubes 96, 98, 100, and 102 may cumulatively increase by approximately 5 to 500, 10 to 250, or 25 to 100 percent from the innermost tube 96 to the outermost tube 102. Furthermore, two or more tubes 50 may include the same diameter, which is different than the diameter of at least one other tube 50. For example, in certain embodiments, the different tube diameters of the plurality of tubes 50 may change in the radial direction 86 away from the central axis 82 of the fuel nozzle 76 only up to the first row 104 of tubes 50 (e.g., tubes 96) or at most the second row 106 of tubes 50 (e.g., tubes 98). In the illustrated embodiment, the tubes 98, 100, and 102 have equal diameters 167, 168, 169, which are greater than the diameter 166 of the tube 96. However, the diameter of tubes 98, 100, and 102 may differ in certain embodiments, e.g., the diameter between tubes 98, 100, and 102 may increase in the radial direction 86 outward or away from axis 82 (see FIG. 9). As illustrated, the flow control features include an increasing diameter from tube 96 to tube 98. The tube diameters 166 and 168 may range from approximately 0.05 inches to 0.3 inches. For example, the tube diameters 166 and 168 may be approximately 0.05, 0.1. 0.15, 0.20, 0.25, or 0.30 inches, or any diameter therebetween. The tube diameters 166 and 168 may affect the fuel/air premixing ratios as described below.

The flow control features of the plurality of tubes 50 also include different fuel/air premixing ratios. Indeed, the different fuel/air premixing ratios of the plurality of tubes 50 change in the radial direction 86 away from the central axis 82 of the fuel nozzle 76. More specifically, the plurality of tubes 50 may include increasing (or decreasing) fuel/air premixing ratios in the radial direction 86 outward or away from the central axis 82. In certain embodiments, the fuel/air premixing ratio may change by approximately 0 to 100, 5 to 50, or 10 to 25 percent from one tube 50 to another in the radial direction 86. For example, the fuel/air premixing ratio may increase by greater than approximately 1, 2, 3, 4, 5, 6, 7, 8, 9, or 10 percent from tube 96 to 98, from tube 98 to 100, and from tube 100 to 102. As illustrated, tube 96 (e.g., innermost row 104 of tubes 50) does not include fuel inlets 132, thus only air flows through tube 96 and no premixing of air and fuel occurs. As a result, the fuel/air ratio for tube 96 is 0. Also, as discussed above, tube 96 has a lesser diameter 166 than tubes 98, 100, and 102. Due to the lesser diameter 166 and lack of fuel inlets 132, the central region 146 of the downstream end portion 46 of the fuel nozzle 76 has a leaner fuel-air mixture than the surrounding region 147, thereby reducing hot spots in the central region 146. In other words, the tube 96 creates a barrier (e.g., air) to reduce combustion in the central region 146, thereby providing a more controlled heat distribution. As a result, the hot zones may be reduced and the operability and durability of the fuel nozzle 76 is increased.

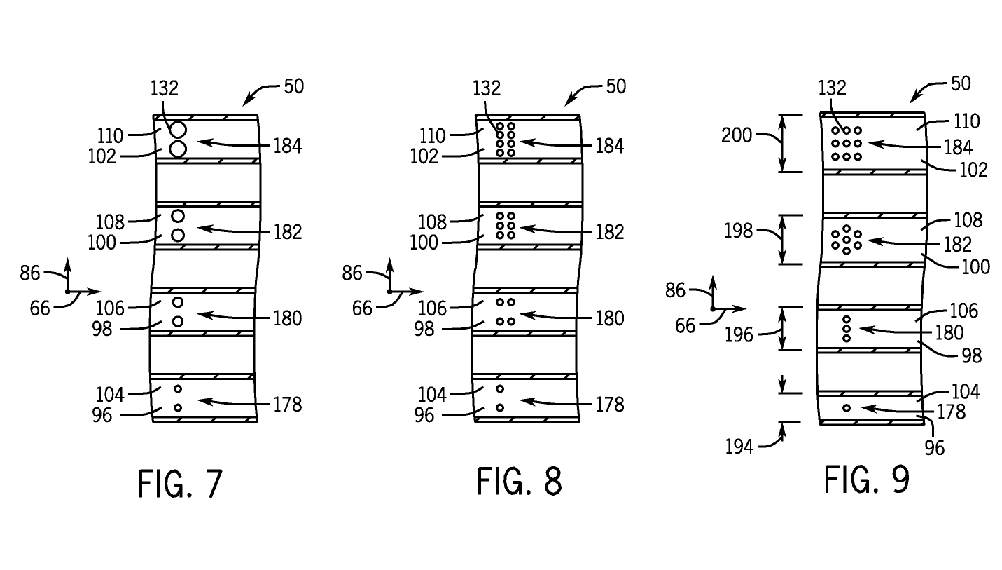

FIGS. 7-9 are partial cross-sectional side views of the fuel nozzle 12 taken within line 7-7 of FIG. 4, illustrating various features that affect fuel/air premixing ratios of the plurality of tubes 50. As illustrated in FIGS. 7-9, each tube 50 includes a set of fuel inlets 132. Tubes 96, 98, 100, and 102 include sets 178, 180, 182, and 184 of fuel inlets 132. In certain embodiments, the sets 178, 180, 182, and 184 of fuel inlets 132 may include different shapes (e.g., rectilinear, keyhole, etc.) or arrangements (e.g., different patterns, distributions, positions, etc.) relative to one another. For example, as illustrated in FIG. 7, the fuel inlets 132 on each tube 50 are radially aligned in the radial direction 86 at the same axial position 66. In certain embodiments, the fuel inlets 132 on each tube 50 may also be aligned one after another in the axial direction 66, or radially and axially aligned with respect to one another (see FIGS. 8 and 9). In some embodiments, the sets 182 and 184 of fuel inlets 132 may include the same features. In other embodiments, the sets 180, 182, and 184 of fuel inlets 132 may include the same features.

As illustrated in FIG. 7, the sets 178, 180, 182, and 184 of the fuel inlets 132 have different sizes relative to one another. The size of the fuel inlets 132 within each set 178, 180, 182, and 184 progressively increases from tube 96 to tube 102 and, thus, increases in the radial direction 86 outward from the central axis 82. For example, the size of the set 180 of fuel inlets 132 on tube 98 is greater than the size of the set 178 of fuel inlets 132 on tube 96, the size of the set 182 of fuel inlets 132 on tube 100 is greater than the size of the set 180 of fuel outlets on tube 98, and the size of the set 184 of fuel inlets 132 on tube 102 is greater than the size of the set 182 of fuel inlets 132 on tube 100. For example, the diameter of the fuel inlets 132 may change (e.g., increase by a factor of approximately 0.1 to 20, 0.1 to 10, or 0.1 to 5 from one tube 50 to another in the radial direction 86. As a result of the increasing fuel outlet sizes, the fuel/air premixing ratios also increase from tube 96 to tube 102 in the radial direction 86. As a result of the increasing sizes of the fuel inlets 132 on the tubes 50, the fuel flow within each tube increases in the radial direction 86. With a leaner fuel flow towards the central region 146 of the fuel nozzle 76, the variable size of the fuel inlets 132 may substantially reduce the recirculation region of hot combustion products 72 across the downstream end portion 46 of the fuel nozzle 76. Thus, the variable size of fuel inlets 132 helps to reduce hot spots to increase operability and durability of the center fuel nozzle 76. In certain embodiments, only the size of the fuel inlets 132 within set 178 differs and the size of the fuel outlets 132 of the other sets 180, 182, and 184 are the same. In other embodiments, the size of the fuel inlets 132 of both sets 178 and 180 differ from each other and the other sets 182 and 184, while the size of the fuel inlets 132 of sets 182 and 184 are the same.

As illustrated in FIG. 8, the sets 178, 180, 182, and 184 of the fuel inlets 132 include different numbers of fuel inlets 132. As illustrated, each set 178, 180, 182, and 184 have a variable number of fuel inlets 132 that changes (e.g., increases) in the radial direction 86. For example, tube 98 has a greater number of fuel inlets 132 (e.g., a total of 4) than tube 96 (e.g., a total of 2) in the fuel chamber 48, tube 100 has a greater number of fuel inlets 132 (e.g., a total of 6) than tube 98 (e.g., a total of 4) in the fuel chamber 48, and tube 102 has a greater number of fuel inlets 132 (e.g., a total of 8) than tube 100 (e.g., a total of 6) than tube 98 in the fuel chamber 48. The number of fuel inlets 132 within each set 178, 180, 182, and 184 increases from tube 96 to tube 102 and, thus increases in the radial direction 86 outward from the central axis 82 to vary the fuel/air ratio in the radial direction 86. For example, the number of fuel outlets 132 may change (e.g., increase) by approximately 0 to 50, 0 to 20, or 0 to 10 percent from one tube 50 to another in the radial direction 86. For example, the number of fuel inlets 132 may change (e.g., increase) by at least 1, 2, 3, 4, 5, 6, 7, 8, 9, or 10, or any other number, from one tube 50 to another in the radial direction 86. The increasing number of fuel inlets 132 on each tube 50 in the radial direction 86 increases the amount of fuel flow into each tube 50, thereby increasing the fuel/air ratio. With a leaner fuel flow towards the central region 146 of the fuel nozzle 76, the variable number of fuel inlets 132 may substantially reduce the recirculation region 72 across the downstream end portion 46 of the fuel nozzle 76, thus better distributing the heat across the downstream end portion 46. Thus, the variable number of fuel inlets 132 helps to reduce hot spots to increase operability and durability of the center fuel nozzle 76. In certain embodiments, a variable size and number (e.g., increasing) of fuel inlets 132 may be disposed on the tubes 50 in the radial direction 86. In some embodiments, the number of the fuel inlets 132 within set 178 differs and the number of the fuel outlets 132 of the other sets 180, 182, and 184 are the same. In other embodiments, the number of the fuel inlets 132 of both sets 178 and 180 differ from each other and the other sets 182 and 184, while the number of fuel inlets 132 of sets 182 and 184 are the same.

FIG. 9 illustrates a further embodiment of the plurality of tubes 50. As illustrated, each set 178, 180, 182, and 184 of fuel inlets 132 on the tubes 50 have different numbers of fuel inlets 132 to affect the fuel/air ratio as described above. In addition, the plurality of tubes 50 has different diameters. Indeed, the plurality of tubes 50 has increasing diameters in the radial direction 86 away or outward from the central axis 82. Tubes 96, 98, 100, and 102 have diameters 194, 196, 198, and 200, respectively. The tube diameters 194, 196, 198, and 200 may range from approximately 0.05 inches to 0.3 inches. For example, the tube diameters 194, 196, 198, and 200 may be approximately 0.05, 0.1. 0.15, 0.20, 0.25, or 0.30 inches, or any distance therebetween. The tube diameters 194, 196, 198, and 200 increase in the radial direction 86 from tube 96 to tube 102. For example, the diameter 196 of tube 98 increases from the diameter 194 of tube 96, the diameter 198 of tube 100 increases from the diameter 196 of tube 98, and the diameter 200 of tube 102 increases from the diameter 198 of tube 100. In certain embodiments, the diameter of tubes 50 may change (e.g., increase) by a factor of approximately 0.1 to 10, 0.1 to 5, or 0.5 to 2 from one tube 50 to another in the radial direction 86. In certain embodiments, an equal amount of air may flow through each tube 50, and thus the increasing diameters may result in a decreasing flow velocity from one tube 50 to another in the radial direction 86. In other embodiments, the increasing diameters of the tubes 50 may result in an increasing flow rate from one tube 50 to another in the radial direction 86. In addition, the number of fuel inlets 132 changes (e.g., increases from one tube 50 to another in the radial direction 86). Thus, in the illustrated embodiment, the combination of variable tube diameters and variable numbers of fuel inlets 132 serve as flow control features to reduce low velocity regions or recirculation regions, thereby reducing the possibility of flame holding, flash back, hot spots, and damage to the fuel nozzle 12 (e.g., 76). In some embodiments, the flow control features may include variable diameters of the tubes 50, variable numbers of fuel inlets 132, variable sizes of fuel inlets 132, variable distances of tubes 50 from the downstream end portion 46, or any combination thereof. In certain embodiments, the different tube diameters of the plurality of tubes 50 may change in the radial direction 86 away from the central axis 82 of the fuel nozzle 12 only up to the first row 104 of tubes 50 (e.g., tubes 96) or at most the second row 106 of tubes 50 (e.g., tubes 98). In some embodiments, the number of the fuel inlets 132 within set 178 differs and the number of the fuel outlets 132 of the other sets 180, 182, and 184 are the same. In other embodiments, the number of the fuel inlets 132 of both sets 178 and 180 differ from each other and the other sets 182 and 184, while the number of fuel inlets 132 of sets 182 and 184 are the same.

Technical effects of the disclosed embodiments include providing the fuel nozzle 12 (e.g., multi-tube fuel nozzle) with different flow control features. The different flow control features may change in the radial direction 86 away from the central axis 82 of the fuel nozzle 12 up to certain rows 80 of tubes 50 in the fuel nozzle 12. In particular, the flow control features may make the air-fuel mixture leaner or provide less contact between the tubes 50 and the flame near the central region 146 of the fuel nozzle 12. For example, the flow control features may include different fuel/air premixing ratios, different tube diameters, or different outlet distances relative to the downstream end portion 46 of the fuel nozzle 12. These flow control features may substantially reduce the recirculation region 72 across the downstream end portion 46, thus reducing hot spots to increase operability and durability of the fuel nozzle 12.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a multi-tube fuel nozzle, comprising:
a fuel conduit;
a fuel chamber coupled to the fuel conduit; and
a plurality of tubes concentrically arranged in a plurality of rows about a central axis of the multi-tube fuel nozzle and extending through the fuel chamber to a downstream end portion of the multi-tube fuel nozzle, wherein the plurality of tubes comprises fluids flow and different flow control features including at least one of different fuel/air premixing ratios, different tube diameters, or different outlet distances relative to the downstream end portion.

2. The system of claim 1, wherein the different flow control features of the plurality of tubes change in a radial direction away from a central axis of the multi-tube fuel nozzle.

3. The system of claim 2, wherein the plurality of tubes comprises at least one of increasing fuel/air premixing ratios, increasing diameters, or increasing outlet distances in the radial direction away from the central axis of the multi-tube fuel nozzle.

4. The system of claim 1, wherein the plurality of tubes comprises the different fuel/air premixing ratios.

5. The system of claim 4, wherein the different fuel/air premixing ratios of the plurality of tubes change in a radial direction away from a central axis of the multi-tube fuel nozzle.

6. The system of claim 4, wherein the plurality of tubes comprises a first tube and a second tube, and the second tube has a greater number of fuel inlets within the fuel chamber than the first tube.

7. The system of claim 4, wherein the plurality of tubes comprises a first tube and a second tube, the first tube comprises a first set of fuel inlets within the fuel chamber, the second tube comprises a second set of fuel inlets within the fuel chamber, and the first and second sets of fuel inlets have different sizes or shapes relative to one another.

8. The system of claim 1, wherein the plurality of tubes comprises the different tube diameters.

9. The system of claim 8, wherein the different tube diameters of the plurality of tubes change in a radial direction away from a central axis of the multi-tube fuel nozzle.

10. The system of claim 1, wherein the plurality of tubes comprises the different outlet distances relative to the downstream end portion.

11. The system of claim 10, wherein the different outlet distances of the plurality of tubes change in a radial direction away from the central axis of the multi-tube fuel nozzle.

12. The system of claim 1, comprising a turbine combustor or a gas turbine engine having the multi-tube fuel nozzle.

13. The system of claim 1, wherein an innermost row of tubes has no fuel flow or at least the innermost row of tubes is flush-mounted relative to the downstream end portion of the multi-tube fuel nozzle.

14. A system, comprising:
a multi-tube fuel nozzle, comprising:
a fuel conduit;
a fuel chamber coupled to the fuel conduit;
a first tube extending through the fuel chamber, wherein the first tube comprises a first axis disposed at a first radial offset from a central axis of the multi-tube fuel nozzle; and
a second tube extending through the fuel chamber, wherein the second tube comprises a second axis parallel to the first axis, the second axis is disposed at a second radial offset from the central axis of the multi-tube fuel nozzle, the second radial offset is greater than the first radial offset, and the first and second tubes comprise fluids flow and are structurally different from one another to define different flow control features.

15. The system of claim 14, wherein the different flow control features of the first and second tubes comprise at least one of different fuel/air premixing ratios, different tube diameters, or different outlet distances relative to a downstream end portion of the multi-tube fuel nozzle.

16. The system of claim 14, wherein the different flow control features comprise an increasing number or an increasing size of fuel inlets from the first tube to the second tube.

17. The system of claim 14, wherein the different flow control features comprise an increasing diameter from the first tube to the second tube.

18. The system of claim 14, wherein the different flow control features comprise different outlet distances between a downstream end portion of the multi-tube fuel nozzle and the first and second tubes, and the different outlet distances increase from the first tube to the second tube.

19. A system, comprising:
a multi-tube fuel nozzle, comprising:
a fuel conduit;
a fuel chamber coupled to the fuel conduit;
a first tube extending through the fuel chamber, wherein the first tube comprises a first axis disposed at a first radial offset from a central axis of the multi-tube fuel nozzle;
a second tube extending through the fuel chamber, wherein the second tube comprises a second axis disposed at a second radial offset from the central axis of the multi-tube fuel nozzle, the second radial offset is greater than the first radial offset; and
a third tube extending through the fuel chamber, wherein the third tube comprises a third axis disposed at a third radial offset from the central axis of the multi-tube fuel nozzle, the third radial offset is greater than the second radial offset, and the first, second, and third tubes comprise fluids flow and at least two different flow control features including different fuel/air premixing ratios, different tube diameters, or different outlet distances relative to a downstream end portion of the multi-tube fuel nozzle.

20. The system of claim 19, wherein the at least two different flow control characteristics comprise an increasing number or size of fuel inlets, increasing diameters, or increasing outlet distances of the first, second, and third tubes in a radial outward direction from the central axis.
